(19) United States
(12) Patent Application Publication
(10) Pub. No.: US 2017/0200316 A1
(43) Pub. Date: Jul. 13, 2017

(54) ADVERTISING SYSTEM FOR VIRTUAL REALITY ENVIRONMENTS

(71) Applicant: SPHERE OPTICS COMPANY, LLC, Syracuse, NY (US)

(72) Inventors: Meyer J. Giordano, Syracuse, NY (US); Robert S. Englert, Jamesville, NY (US); Zachary J. Port, Syracuse, NY (US)

(21) Appl. No.: 15/348,184

(22) Filed: Nov. 10, 2016

Related U.S. Application Data
(60) Provisional application No. 62/216,446, filed on Sep. 10, 2015.

(51) Int. Cl. G06T 19/00; G06Q 30/02; G09G 5/14; G06T 19/20; G06F 3/01; G02B 27/01

(52) U.S. Cl. CPC G06T 19/006; G06F 3/012; G02B 27/017; G09G 5/14; G06F 3/013; G06T 19/20; G06Q 30/0277; G06Q 30/0273; G09G 2354/00; G09G 2340/125; G09G 2320/10

(57) ABSTRACT

A virtual reality (VR) advertising framework is presented wherein content is displayed on different layers which surround the user. A process includes defining a user's view of a VR environment in 3D space by the angle of the user's head. Defined areas of the 3D VR space include a spherical 3D mesh primary content shell that surrounds the user and has 360° video content digitally mapped to and played back upon it; a second 3D mesh advertising shell contained within the spherical content shell 3D mesh and centered on the user's viewpoint and divided into grid squares wherein advertising content is placed; and a transparent rectangular plane HUD shell that comprises content kept in the user's field of view and is anchored to the user's viewpoint, wherein imagery mapped to the HUD shell is kept in a fixed position in the user's field of view.

### BACKGROUND

Virtual Reality (VR) technology devices provide audial and visual presentations to a user that simulates the experience of being in an alternate space, by substituting visual and auditory sensory data otherwise provided by a user's physical surroundings with visual and auditory sensory data of another environment. FIG. 1 provides photographic illustrations of three different VR devices: an Oculus Rift 2, Samsung Gear VR 4, and HTC Vive 6. Hundreds of thousands of VR units have been sold to software developers working to create content for the devices. VR units provide opportunities to develop and present new modes of content not possible with previous technologies, such as conventional graphic display devices.

### BRIEF SUMMARY

In one aspect of the present invention, a computerized method for presenting a virtual reality advertising framework wherein content is displayed on different layers which surround a user includes executing steps on a computer processor. Thus, a computer processor configured by an aspect of the present invention defines a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space. The processor defines a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint. Thus, the processor drives the advertising shell to display advertising shell content to the user simultaneously with driving the primary content shell to display the portions of 360-degree virtual reality environment video content that are mapped to the user's viewpoint.

In another aspect, a system has a hardware processor in circuit communication with a computer readable memory and a computer-readable storage medium having program instructions stored thereon. The processor executes the program instructions stored on the computer-readable storage medium via the computer readable memory and is thereby configured by an aspect of the present invention to define a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space. The processor defines a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint. Thus, the processor drives the advertising shell to display advertising shell content to the user simultaneously with driving the primary content shell to display the portions of 360-degree virtual reality environment video content that are mapped to the user's viewpoint

In another aspect, a computer program product for presenting a virtual reality advertising framework wherein content is displayed on different layers which surround a user has a computer-readable storage medium with computer readable program code embodied therewith. The computer readable hardware medium is not a transitory signal per se. The computer readable program code includes instructions for execution which cause the processor to define a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space. The processor is caused to define a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint. Thus, the processor is caused to drive the advertising shell to display advertising shell content to the user simultaneously with driving the primary content shell to display the portions of 360-degree virtual reality environment video content that are mapped to the user's viewpoint.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts photographic illustrations of prior art VR devices.

FIG. 2 depicts a computerized aspect according to an embodiment of the present invention.

FIG. 3 is a flow chart illustration of a process or system according to an embodiment of the present invention.

FIG. 4 is a graphic illustration of content shells according to an aspect of the present invention.

FIG. 5 is a composite graphic illustration of content shells according to an aspect of the present invention.

FIG. 6 is a graphic illustration of content shells according to an aspect of the present invention.

FIG. 7 is a graphic illustration of a HUD content shell according to an aspect of the present invention.

FIG. 8 depicts a computerized aspect according to an embodiment of the present invention.

FIG. 9 depicts a computerized aspect according to an embodiment of the present invention.

### DETAILED DESCRIPTION

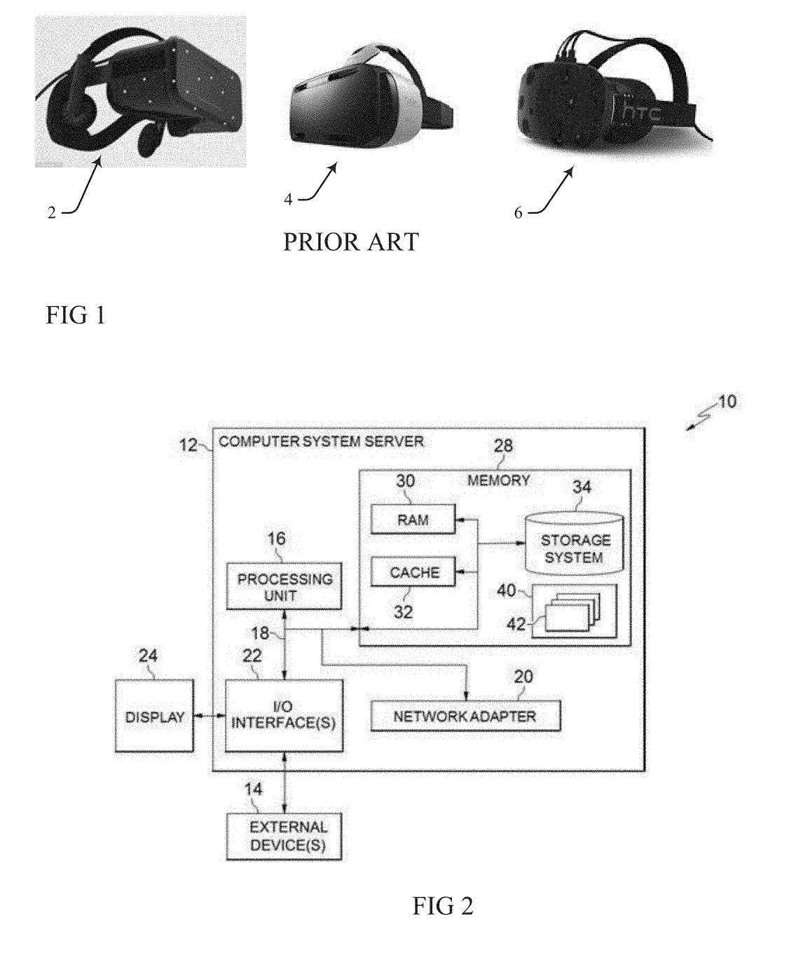

FIG. 2 is a schematic of an example of a programmable device implementation 10 according to an aspect of the present invention, which may function as a cloud computing node. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

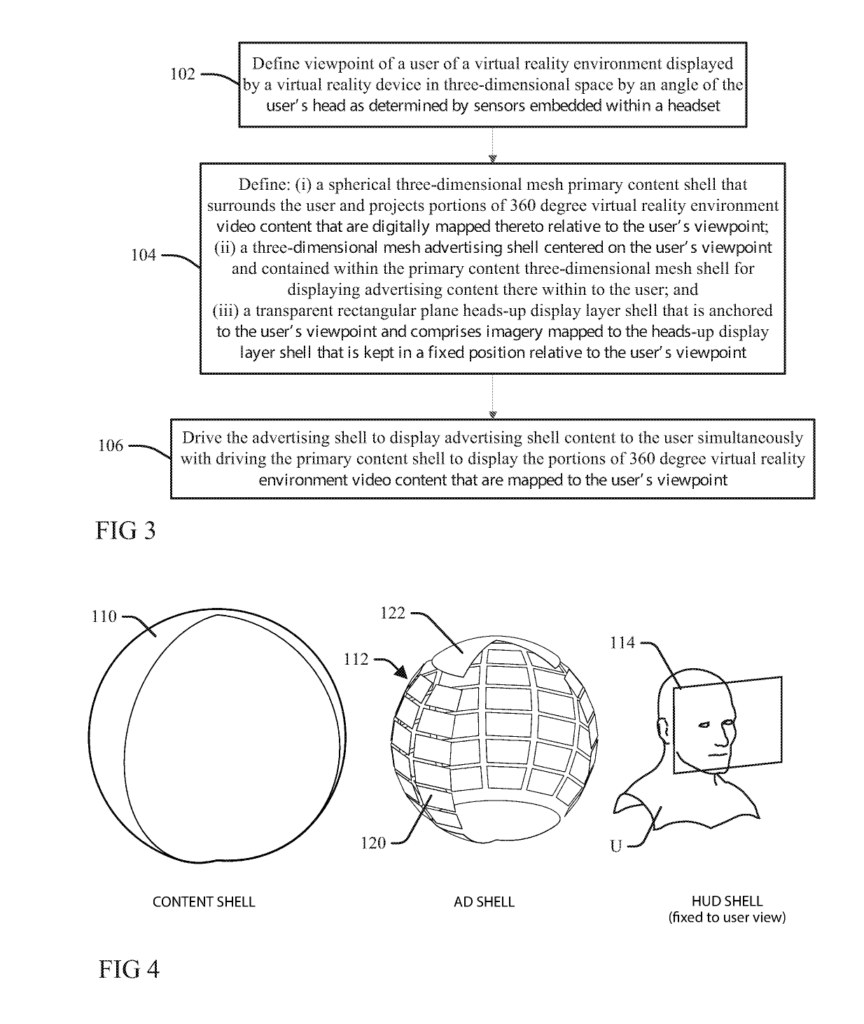

FIG. 3 is a flow chart illustration of a computer-implemented process, method or system according to the present invention for presenting a virtual reality advertising framework wherein content is displayed on different layers which surround a user.

At 102 a processor configured according to the present invention defines a viewpoint of a user of a virtual reality environment displayed by a virtual reality device in three-dimensional space to the user by an angle of the user's head as determined by sensors embedded within a headset. Physical head rotation is translated into virtual rotation of the viewpoint within the three-dimensional space.

At 104 the processor defines a plurality of different main areas of the three-dimensional virtual reality space projected to the user that comprises: (i) a spherical three-dimensional mesh primary content shell that surrounds the user and projects portions of 360 degree virtual reality environment video content that are digitally mapped thereto relative to the user's viewpoint; (ii) a three-dimensional mesh advertising shell centered on the user's viewpoint and contained within the primary content three-dimensional mesh shell for displaying advertising content there within to the user; and (iii) a transparent rectangular plane heads-up display layer shell that is anchored to the user's viewpoint and comprises imagery mapped to the heads-up display layer shell that is kept in a fixed position relative to the user's viewpoint.

At 106 the processor drives the advertising shell to display advertising shell content to the user simultaneously with driving the primary content shell to display the portions of 360-degree virtual reality environment video content that are mapped to the user's viewpoint.

FIG. 4 provides graphic illustrations of a spherical three-dimensional mesh primary content shell 110, a three-dimensional mesh advertising shell 112 and a transparent rectangular plane heads-up display layer shell 114 that is fixed to the viewpoint of a user U. FIG. 5 shows the three shells 110, 112 and 114 located relative to each in an illustrative but not limiting or exhaustive example composite view or arrangement according to an aspect of the present invention.

Aspects of the present invention provide for the delivery of advertising or other sponsored material within the advertising shell 112 or the heads-up display (HUD) layer 114 simultaneously (alongside) primary content displayed in the primary content shell 110. For many media, selling advertising time or space is a primary source of revenue, and some industries would not be economically feasible otherwise. Systems for managing and delivering advertising material within a simulated VR environment according to the present invention provide advantages in ensuring viability of VR as a commercial medium. More particularly, aspects present a VR advertising framework wherein content is on different layers or “shells” which surround the user.

VR environments are typically designed as a 3D space. Aspects define the user's view of the environment by the angle of their head, as read by sensors embedded within their headset. Physical head rotation is thereby translated into virtual rotation of the viewpoint within the simulated 3D space. This 3D space can be populated with any sort of digital content, such as fully rendered environments, 360° video, or abstract data. Aspects provide standardized placement of advertisements within this 3D VR, space to facilitate its efficient and effective utilization.

The “content shell” or primary content shell 110 generally includes content of a simulated environment that the user intends to view or experience. This could be most easily understood as a spherical 3D mesh that surrounds the user and has 360° video content digitally mapped to and played back upon it. However, it could also represent an infinite 3D space that includes all the primary content within a given environment.

The advertising shell 112 is where advertising content is placed. This can be imagined as a second 3D mesh contained within the larger mesh of the content shell, and centered on the user's viewpoint.

The HUD layer or shell 114 is where content that should always be kept in the user's field of view is placed. The HUD shell 114 may be a semi or generally transparent rectangular plane that is anchored to the user's viewpoint, such that the imagery mapped to it is kept in a fixed position in the user's field of view. Advertising or informational content (time, data use, etc.) can be displayed here.

The advertising shell 112, and to an extent, the HUD shell 114, are what comprise the proposed system, whereas the content shell 110 contains the VR content the user intends to experience.

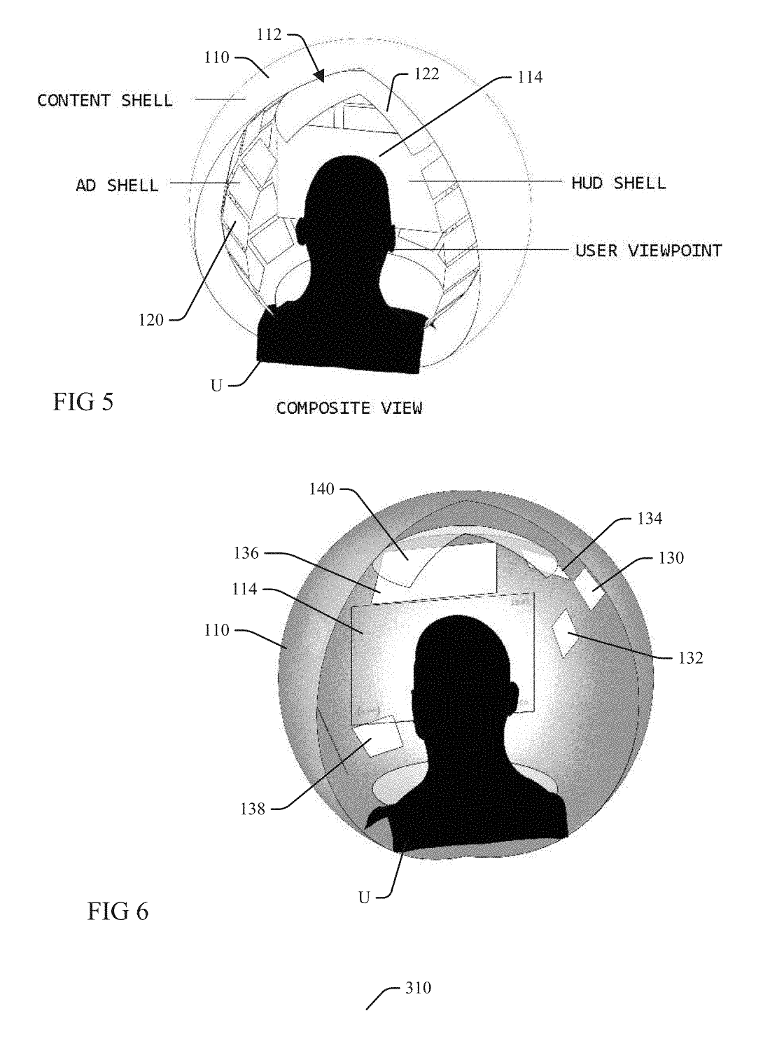

Referring again to FIGS. 4 and 5, in some aspects the advertising shell is divided up into several different, individual portions, including grid squares 120 and a polar region 122, which are analogous to the grid layouts used to define advertising space in newspapers or magazines, and wherein each more comprise different content. FIG. 6 shows a plurality of different grids 130, 132, 134, 136 and 138 and a polar cap region 140 that may be sold to advertisers on individual basis, at varying rates dependent on the relative desirability of their positions relative to the user's viewpoint or to others grid 120 or cap 122 portions. Relative desirability may also vary based on content displayed therein, or in the primary shell 110.

Generally, advertising shell sections 132 and 136 that are closer to a horizon or neutral viewing position of the user will be substantially more expensive than those closer to a zenith/nadir position (130, 134) or to the bottom edge of perceptible vision (138). The polar cap region 140 may be defined was within a zenith/nadir of the advertising sphere, and in some aspects, is more circular or provides a larger canvas for advertisers relative to the grids 130 through 138, somewhat equivalent to the back cover of a magazine.

Various permutations can be applied to the advertising shell sub-segments 120, 122, such as scaling up/down, translation in 3D space, transparency, or receding/advancing in perceived depth without scaling in size. The content of the segments may be animated or static, and may have an opaque or transparent background. Opaque backgrounds may be desirable to maintain visual consistency and clear separation. These permutations may be applied in a constant state, or vary across time.

The relative opacity of advertisements displayed within the shell 112 may vary based on the user's tier of content delivery service. For example, the ads seen by user of a fully free, ad-supported service may have a much higher opacity than those displayed to a user who has paid some premium or other consideration for a VR service.

Opacity may also vary based on the user's eye gaze, such that advertisements become more or less opaque depending on whether or not the user is staring directly at them. Ads that the user fixates on may become fully opaque, enlarge, or provide the option to pause the primary content and display additional information regarding the advertised product. Ads that are in the user's peripheral vision may also gradually fade in/out as the viewpoint of the user approaches or move away from their positions.

At times, the entire advertising shell may be consumed with a single advertisement that takes over the entire VR environment, like the way television advertisements replace the normal programming. These may fade in at predefined points, or after content has been viewed for a particular time period. In some cases, these full-environment ads may remain throughout the entire presentation at a very low opacity, to provide a sort of “watermark” effect.

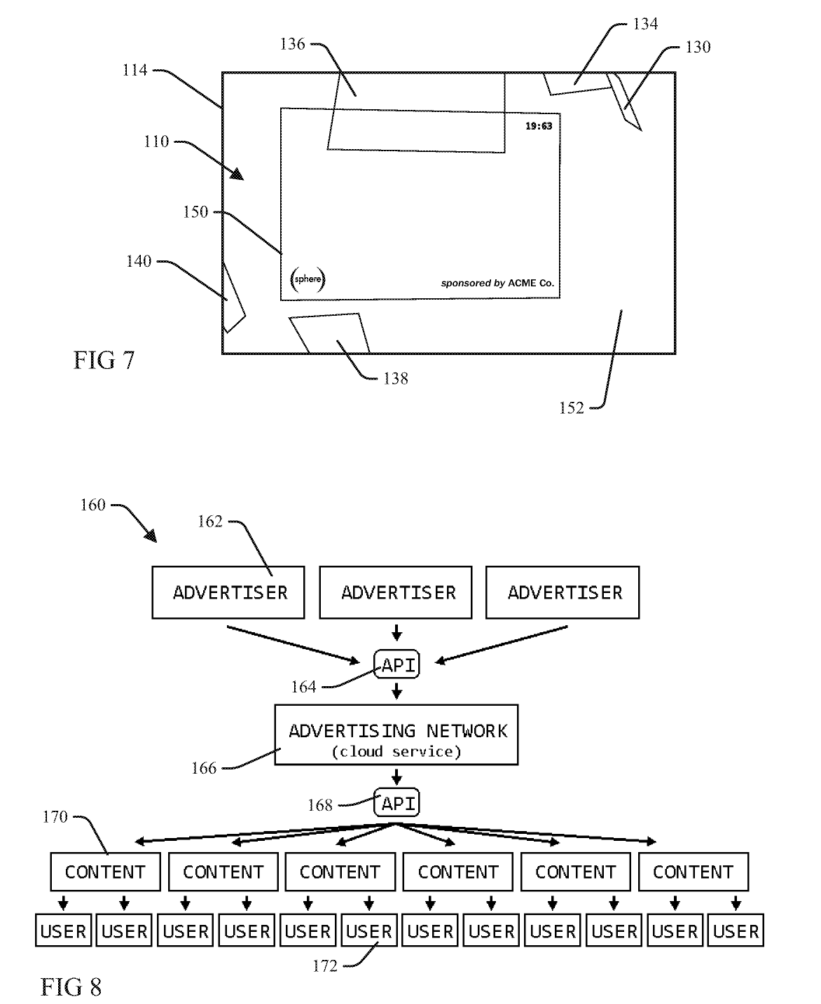

Referring now to FIG. 7, the HUD layer 114 can be used to display content to the user constantly, regardless of their angle of view, as the HUD layer moves within the view of the user. Various messages can be overlaid here, for example, a centered message 150, displayed with different opacity and translation settings set relative to content displayed within each of the primary shell 110 or advertising shell portions 130, 134, 136, 138 and 140 visible through the HUD shell 114. In some aspects, the HUD display shell 114 content settings are comparable to lower thirds or watermarking settings used in the display of television programming, but overlaid in the format of a heads-up display. This layer can be subdivided into individually salable grid units (for example, the central portion 150 relative to a remainder surrounding portion 152) in the same way as previously described with respect to the advertising shell 112.

FIG. 8 illustrates a centralized server and cloud infrastructure 160 of an aspect of the present invention. Different advertisers 162 provide advertising content via an application programming interface (API) 164 to a cloud-based advertising network 166, which in turn uses another API interface 168 to place different content items 170 into the advertising shells 112 or HUD layers 114 of different users 172. Aspects may provide standardized models to all users 172 of the system, and automatically update geometry of the meshes of the shells 110 and 112 and advertising content displayed within the advertising shell 112. Content providers 162 employing the system may connect with the centralized system via the API 164 to facilitate the maintenance of the material provided for display to the users 172.

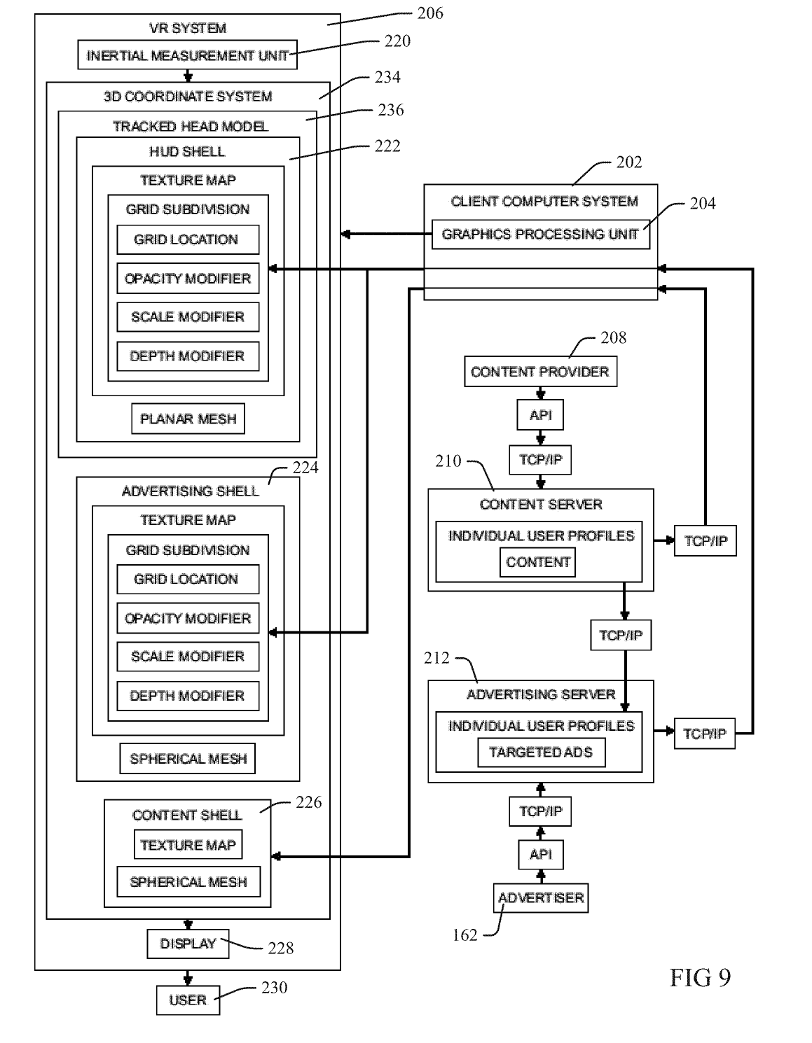

FIG. 9 is a high level, block diagram illustration of an implementation of an aspect of the present invention. An advertiser 162 communicates with an advertising server 212 through an API using Transmission Control Protocol/Internet Protocol (TCP/IP) communications to select targeted ads appropriate to an individual user profile data stored on or accessed by the advertising server 212 for a user 230 viewing a virtual reality environment via a VR headset system 206.

A content provider 208 provides virtual reality content through API and TCP/IP interfaces to content server 210, which is selects or modifies the content as required in response to user profiles of the user 230 stored on or accessed by the content server 210.

A graphics processing unit 204 of a client computer system 202 communicates with the VR system 206 worn (operated) by the user 230 to select and drive displays by display component 228 of the VR system 206 of content provided by the content server 210 and advertising server 212 within appropriate primary content shell 236, advertising shell 224 and HUD shell 222 elements, as described above.

An inertial measurement unit 220 provides location data to a 3-D coordinate system 234 that locates the gaze and viewpoint data for the user with respect to the shells 222, 224 and 226. A tracked head model 236 tracks movement of the user's head, and thereby the gaze and viewpoint data, as a function of the 3-D coordinate system 234 data and the inertial measurement unit data 220, and thereby keeps the planar HUD shell 222 located directly in front of the user's gaze.

The content shell 226 presents the virtual reality content from the content provider 208 by use of texture map and spherical mesh data or components.

In the present example, the HUD shell 222 has a planar mesh structure and the advertising shell 224 has a spherical mesh structure. Each of the HUD shell 222 and advertising shell 224 use respective texture map, grid subdivision, grid location, opacity modifier, scale modifier, and depth modifier components, elements or data to render their respective graphic contents to the user 230 via the display 228.

Potential advertisers could buy advertising space through the owner/maintainer of the advertising network, who would then propagate the advertisers' materials to the content providers via the cloud infrastructure. The advertising network could maintain profiles for individual end consumers and deliver targeted advertising based on known preferences. The use of the network simplifies the process for advertisers, who would only need to submit their material to the network maintainer, which would then push the content to the system's installed base.

By providing a consistent standard to design VR advertising content as a function of user viewpoint, aspects of the present invention help to streamline content development and maximize the consistency of the VR experience, and facilitate the incorporation of advertising into VR without excessively compromising the experience and undermining it to the extent that users lose interest in the medium.

We claim:

1. A computer-implemented method for presenting a virtual reality advertising framework wherein content is displayed on different layers which surround a user, the method comprising executing on a processor the steps of:
defining a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space;
defining a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint; and
driving the advertising shell to display advertising shell content to the user simultaneously with driving the primary content shell to display the portions of 360-degree virtual reality environment video content that are mapped to the user's viewpoint.

2. The method of claim 1, wherein the displayed advertising shell content is selected from the group consisting of advertisement content, promotion content and informational content.

3. The method of claim 1, wherein the portions of the 360-degree virtual reality environment video content are selected from the group consisting of a fully rendered physical environment, 360-degree video content, and an abstract data rendering.

4. The method of claim 1, further comprising:
subdividing the advertising shell into a plurality of different grid squares; and
projecting different content items of the advertising shell content within each of the plurality of different grid squares.

5. The method of claim 4, further comprising:
assessing different advertisement fees for projecting content items in the different grid squares as a function of differences in positioning of the grid squares relative to the user's viewpoint.

6. The method of claim 5, wherein the different assessed advertisement fees are higher ones of the grid squares that are located closer to a neutral horizon viewing position of the user, relative to the advertisement fees assessed to ones of the grid squares that are located closer to a nadir zenith viewing position of the user.

7. The method of claim 4, further comprising:
separating a portion of the advertising shell that is located at a nadir zenith viewing position of the user into a plurality of circular polar cap regions.

8. The method of claim 1, further comprising:
varying a relative opacity of advertisements that are displayed in the advertising shell in response to determining a value of opacity criteria that is selected from the group consisting of a tier of content delivery service of the user, and a determined direction of eye gaze of the user.

9. The method of claim 8, wherein the opacity criteria comprises the determined direction of eye gaze, the method further comprising:
rendering a first advertisement more opaque in response to determining that the eye gaze direction is not directed toward the first advertisement as displayed in the advertising shell; and
rendering a second advertisement less opaque in response to determining that the eye gaze direction is directed toward the second advertisement as displayed in the advertising shell.

10. The method of claim 9, further comprising:
in response to determining that the eye gaze direction is directed toward the second advertisement as displayed in the advertising shell, executing another action selected from the group consisting of enlarging the second advertisement, pausing display of the portions of 360-degree virtual reality environment video within the primary shell, and displaying additional information regarding a product advertised in the second advertisement within the primary shell.

11. The method of claim 9, further comprising:
fading out the first advertisement in response to determining that the display of the first advertisement within the advertising shell is located within a peripheral vision of the user, relative to the user's viewpoint.

12. The method of claim 9, further comprising:
in response to determining that the eye gaze direction is directed toward the second advertisement as displayed in the advertising shell, displaying the second advertisement over an entirety of the primary shell, thereby displacing the portions of 360-degree virtual reality environment video content within the primary content shell.

13. The method of claim 1, further comprising:
fading, at a predefined point located relative to the user's viewpoint, content displayed in the advertising shell, in response to determining that the displayed content has been viewed by the user for an elapsed viewing time period

14. The method of claim 1, further comprising:
maintaining display of content in the advertising shell at a low opacity level throughout an entirety of displaying the portions of 360-degree virtual reality environment video content in the primary content shell.

15. The method of claim 1, further comprising:
subdividing the heads-up display layer shell into a plurality of individual heads-up display grids; and differentially displaying a plurality of different content items to the user in the individual heads-up display grids with different respective values of opacity.

16. The method of claims 15, further comprising:
assessing different advertising rates for content providers for each of the individual heads-up display grids as a function of differences in their respective values of opacity.

17. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of defining the user's viewpoint by the angle of the user's head as determined by the sensors embedded within the headset, defining the plurality of different main areas of the three-dimensional virtual reality space projected to the user that comprises the spherical three-dimensional mesh primary content shell and advertising shell and the transparent heads-up display layer shell, and driving the advertising shell to display the advertising shell content to the user simultaneously with driving the primary content shell to display the portions of 360 degree virtual reality environment video content that are mapped to the user's viewpoint.

18. The method of claim 17, wherein the program code instructions are provided as a service in a cloud environment.

19. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
defines a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space;
defines a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint; and
drives the advertising shell to display advertising shell content to the user simultaneously with driving the primary content shell to display the portions of 360-degree virtual reality environment video content that are mapped to the user's viewpoint.

20. A computer program product for presenting a virtual reality advertising framework wherein content is displayed on different layers which surround a user, the computer program product comprising:
a computer readable storage medium having computer readable program code embodied therewith, wherein the computer readable storage medium is not a transitory signal per se, the computer readable program code comprising instructions for execution by a processor that cause the processor to:
define a viewpoint of a user of a virtual reality environment displayed by a virtual reality device in three-dimensional space to the user by an angle of the user's head as determined by sensors embedded within a headset, and wherein physical head rotation is translated into virtual rotation of the viewpoint within the three-dimensional space;
define a plurality of different main areas of the three-dimensional virtual reality space projected to the user that comprises a spherical three-dimensional mesh primary content shell that surrounds the user and projects portions of 360 degree virtual reality environment video content that are digitally mapped thereto relative to the user's viewpoint, a three-dimensional mesh advertising shell centered on the user's viewpoint and contained within the primary content three-dimensional mesh shell for displaying advertising content there within to the user, and a transparent rectangular plane heads-up display layer shell that is anchored to the user's viewpoint and comprises imagery mapped to the heads-up display layer shell that is kept in a fixed position relative to the user's viewpoint; and
drive the advertising shell to display advertising shell content to the user simultaneously with driving the primary content shell to display the portions of 360-degree virtual reality environment video content that are mapped to the user's viewpoint.
